(19) United States
(12) Patent Application Publication
(10) Pub. No.: US 2026/0246372 A1
(43) Pub. Date: Aug. 20, 2026

(54) SEMICONDUCTOR DEVICE DRIVE CIRCUIT

(71) Applicant: Mitsubishi Electric Corporation, Chiyoda-ku, Tokyo (JP)

(72) Inventors: Yohei MITSUI, Tokyo (JP); Takayoshi MIKI, Tokyo (JP); Shota MORISAKI, Tokyo (JP)

(73) Assignee: Mitsubishi Electric Corporation, Chiyoda-ku, Tokyo (JP)

(21) Appl. No.: 19/159,501

(22) PCT Filed: Mar. 10, 2023
(86) PCT No.: PCT/JP2023/009436

§ 371 Date: Aug. 25, 2025

(51) Int. Cl. H02M 1/38; H02M 1/088; H02M 1/32; H02M 7/5387

(52) U.S. Cl. CPC H02M 1/385; H02M 1/088; H02M 1/325; H02M 7/5387

(57) ABSTRACT

Drive circuits include control units that each individually control a corresponding one of semiconductor devices of upper and lower arms connected in series, and each apply a gate voltage to the corresponding one of the semiconductor devices to drive the semiconductor device. The drive circuits detect short circuit of the semiconductor devices of the upper and lower arms based on main terminal voltages of the semiconductor devices. After turning on of one semiconductor device of an arm on a driven side, each of the control units performs control to temporarily increase the gate voltage applied to the semiconductor device to a first voltage higher than a predetermined voltage. The control unit controlling driving on an arm different from the arm on the driven side detects the short circuit of the semiconductor devices of the upper and lower arms based on the main terminal voltages.

### FIELD

The present disclosure relates to a semiconductor device drive circuit that drives semiconductor devices of upper and lower arms connected in series with each other.

### BACKGROUND

A power conversion device including semiconductor devices of upper and lower arms connected in series with each other may be subjected to a phenomenon called upper-and-lower-arms short circuit, in which the semiconductor devices of the upper and lower arms are both simultaneously in an “on” state accidentally. An upper-and-lower-arms short circuit causes a high short-circuit current to flow into the semiconductor devices of the upper and lower arms, which may cause a damage in the semiconductor devices. Patent Literature 1 mentioned below discloses a technology to detect an upper-and-lower-arms short circuit on the basis of a voltage across a sense resistor connected to a sense terminal of a semiconductor device and a collector voltage of that semiconductor device.

There are various methods for detecting an upper-and-lower-arms short circuit. When the semiconductor devices are insulated gate bipolar transistors (IGBTs), typical methods include a method in which the collector current is monitored, a method in which the emitter current is monitored, and a method in which the collector voltage is monitored. The method for detecting an upper-and-lower-arms short circuit on the basis of the collector voltage is referred to herein as “collector voltage-based detection method”.

When the collector voltage-based detection method is used, the detection unit includes a first capacitor for holding a detection voltage, and the first capacitor has one end connected to the collector of the semiconductor device via at least one resistor. A second capacitor may be connected in parallel with and across this at least one resistor.

### CITATION LIST

### Patent Literature

Patent Literature 1: Japanese Patent Application Laid-open No. 2019-187172

### SUMMARY OF INVENTION

### Problem to be Solved by the Invention

In the collector voltage-based detection method when the semiconductor device of one arm of the upper and lower arms connected in series with each other is in an “on” state, and under such condition, the semiconductor device of the other arm of the upper and lower arms is accidentally turned on the semiconductor devices of the upper and lower arme will have resistance values close to each other. This causes the voltage applied to the semiconductor device of the other arm to be divided according to the resistance values of the respective semiconductor devices of the upper and lower arms. This phenomenon is referred to herein as “voltage sharing”. Voltage sharing causes a rapid decrease of the collector voltage of the semiconductor device of the other arm accidentally turned on, thereby causing a current to flow from the detection unit to the collector via the second capacitor. This current flows to impede charging of the first capacitor, and therefore presents a problem of a time lag in detection of an upper-and-lower-arms short circuit. The collector voltage-based detection method therefore requires prevention of a time lag in detection.

The present disclosure has been made in view of the foregoing, and it is an object of the present disclosure to provide a semiconductor device drive circuit capable of preventing a time lag in detection that may occur in the collector voltage-based detection method.

### Means to Solve the Problem

To solve the problem and achieve the object. described above, a semiconductor device drive circuit according to the present disclosure for detecting a short circuit of semiconductor devices of upper and lower arms connected in series with each other on a basis of main terminal voltages of the semiconductor devices, the semiconductor device drive circuit comprising control units the control units each individually controlling a corresponding one of the semiconductor devices of the upper and lower arms, and each applying a gate voltage to the corresponding one of the semiconductor devices to drive the one of the semiconductor devices. After turning on of one of the semiconductor devices of an arm on a driven side, each of the control units performs control to temporarily increase a gate voltage applied to the one of the semiconductor devices to a first voltage, the first voltage being higher than a predetermined voltage. A control unit of the control units that controls driving on an arm different from the arm on the driven side detects the short circuit of the semiconductor devices of the upper and lower arms on a basis of the main terminal voltages.

### Effects of the Invention

A semiconductor device drive circuit according to the present disclosure provides an advantageous effect in capability of preventing a time lag in detection that may occur in the collector voltage-based detection method.

### BRIEF DESCRIPTION OF DRAWINGS

FIG. 1 is a schematic circuit diagram for describing a connection relationship between drive circuits and semiconductor devices driven thereby, according to a first embodiment.

FIG. 2 is a diagram illustrating an example of a power conversion device that uses the drive circuits according to the first embodiment.

FIG. 3 is a diagram for describing short circuit modes expected in relation to the drive circuits according to the first embodiment.

FIG. 4 is a diagram illustrating an example of a short circuit detection circuit included in each of the drive circuits according to the first embodiment.

FIG. 5 is a set of diagrams for describing an operation in short circuit mode (1) performed in a typical short circuit detection circuit.

FIG. 6 is a set of diagrams for describing an operation in short circuit mode (2) performed in a typical short circuit detection circuit.

FIG. 7 is a diagram for describing a displacement current that may flow in short circuit mode (2) in the typical short circuit detection circuit.

FIG. 8 is a set of diagrams for describing a control method to be used in the drive circuits according to the first embodiment.

FIG. 9 is a diagram illustrating an example of hardware configuration for implementing functionality of the control unit included in each of the drive circuits according to the first embodiment.

FIG. 10 is a diagram for describing a first control method to be used in the drive circuits according to a second embodiment.

FIG. 11 is a diagram for describing a second control method to be used in the drive circuits according to the second embodiment.

### DESCRIPTION OF EMBODIMENTS

A semiconductor device drive circuit (hereinafter referred to shortly as “drive circuit” as appropriate) according to embodiments of the present disclosure will be described in detail below with reference to the accompanying drawings. Note that suffixed reference characters are used in the following description to indicate two or more components having the same or similar functionality, but the suffixes may be omitted as appropriate when no distinction is made among such components.

### First Embodiment

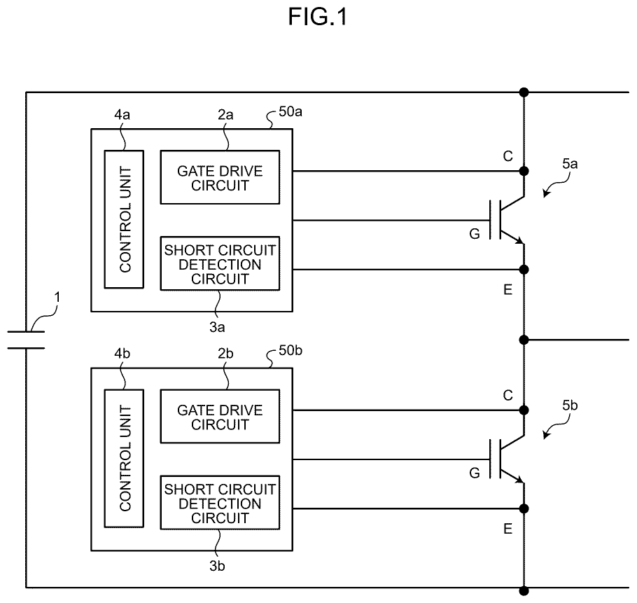

FIG. 1 is a schematic circuit diagram for describing a connection relationship between drive circuits and semiconductor devices driven thereby, according to a first embodiment. Drive circuits 50 according to the first embodiment each individually drive a corresponding one of semiconductor devices 5a and 5b of upper and lower arms connected in series with each other. The pair of the semiconductor devices 5a and 5b connected in series with each other is connected across a direct-current (DC) power source 1, and operates to open and close a flow of electrical power supplied from the DC power source 1, that is, operates to switch between a power supply state and a power cut-off state.

Each of the drive circuits 50 is connected to the collector (C), the gate (G), and the emitter (E) of the corresponding one of the semiconductor devices 5. A drive circuit. 50a drives the semiconductor device Sa of the upper arm, and a drive circuit 50b drives the semiconductor device 5b of the lower arm. Although FIG. 1 illustrates a case where the semiconductor devices 5a and 5b are IGBTs as an example, the semiconductor devices 5a and 5b may be semiconductor devices other than IGBTs. Another example of the semiconductor devices 5a and 5b is a metal oxide semiconductor field effect transistor (MOSFET). In addition, although FIG. 1 illustrates the semiconductor devices Sa and 5b each as a single element, the semiconductor devices 5a and 5b may each be formed of multiple elements connected in parallel with each other.

The drive circuit 50a includes a gate drive circuit 2a, a short circuit detection circuit 3a, and a control unit 4a. The drive circuit 50b similarly includes a gate drive circuit 2b, a short circuit detection circuit 3b, and a control unit 4b. The gate drive circuit 2 applies a drive voltage between the gate and the emitter of the semiconductor device 5 to drive the semiconductor device 5. The short circuit detection circuit 3 detects a short circuit of the corresponding one of the semiconductor devices 5a and 5b of the upper and lower arms on the basis of collector-emitter voltages of the semiconductor devices 5. The drive voltage applied between the gate and the emitter is referred to herein as “gate voltage” as appropriate, and the collector-emitter voltage is referred to herein as “main terminal voltage” as appropriate. The control unit 4 performs control to drive the semiconductor device 5, and when the short circuit detection circuit 3 detects a short circuit of the corresponding one of the semiconductor devices 5a and 5b of the upper and lower arms, the control unit 4 performs control to turn off the semiconductor device 5 under control.

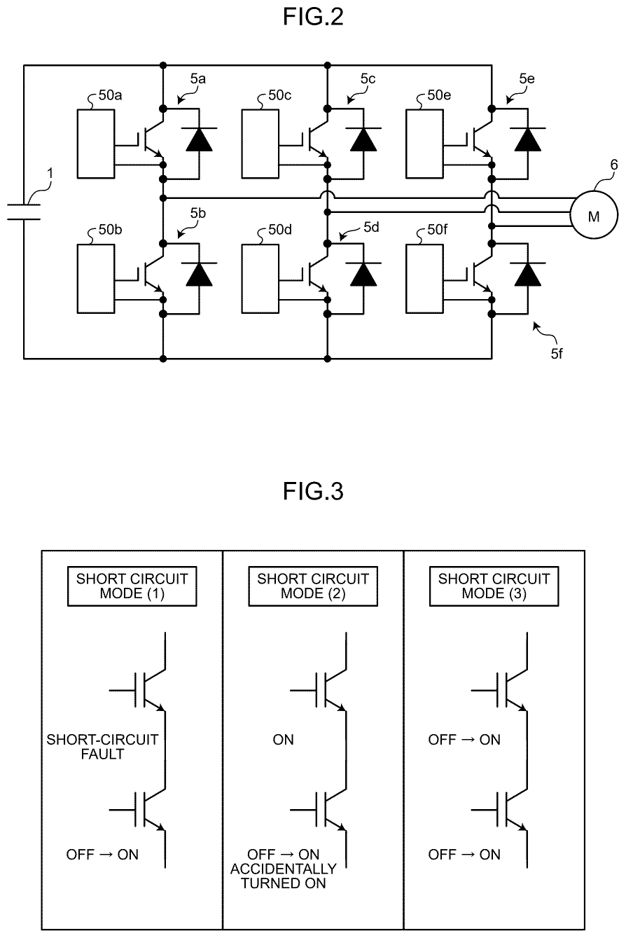

FIG. 2 is a diagram illustrating an example of a power conversion device that uses the drive circuits according to the first embodiment. In FIG. 2, components the same as or equivalent to the components in FIG. 1 are designated by like reference characters. FIG. 2 also illustrates, in addition to the semiconductor devices 5a and 5b, a pair of semiconductor devices 5c and 5d of upper and lower arms connected in series with each other and a pair of semiconductor devices 5e and 5f of upper and lower arms connected in series with each other. These six semiconductor devices 5a to 5f connected in a three-phase bridge configuration, form a three-phase inverter circuit, and are connected to a motor 6. The three-phase inverter circuit converts DC power supplied from the DC power source 1 into three-phase alternating-current (AC) power for the motor 6, and supplies the three-phase AC power to the motor 6. Although FIG. 2 illustrates a case where the semiconductor devices 5a to 5f are IGBTs as an example, the semiconductor devices 5a to 5f may be MOSFETs or the like. In addition, FIG. 2 illustrates a configuration by way of example in which a diode is connected in antiparallel with each of the IGBTs, but when the semiconductor devices 5 are MOSFETs, the semiconductor devices 5 may each implement a similar function by a body diode included in each of the MOSFETS.

The drive circuit 50 according to the first embodiment detects an upper-and-lower-arms short circuit of the semiconductor devices 5a and 5b using the collector voltage-based detection method. The collector voltage-based detection method is a method for detecting an upper-and-lower-arms short circuit on the basis of the collector-emitter voltages, which are the main terminal voltages, of the semiconductor devices 5. Note that the collector-emitter voltage is hereinafter referred to simply as “collector voltage” for simplicity.

FIG. 3 is a diagram for describing short circuit modes expected in relation to the drive circuits according to the first embodiment. The short circuit modes are modes resulting from classification of the manner of action upon occurrence of an upper-and-lower-arms short circuit on the basis of the state or states of the semiconductor device or devices 5 and of the manner of switching control performed on the semiconductor device or devices 5. FIG. 3 illustrates three short circuit modes (1) to (3) as the short circuit modes.

Short circuit mode (1) is a mode of occurrence of an upper-and-lower-arms short circuit caused when the semiconductor device 5 of one arm is in a short-circuit fault state and the semiconductor device 5 of the other arm is turned on, that is, the semiconductor device 5 of the other arm is switched from an “off” state to an “on” state. Short circuit mode (2) is a mode of occurrence of an upper-and-lower-arms short circuit caused when the semiconductor device 5 of one arm is in an “on” state and the semiconductor device 5 of the other arm is accidentally turned on. Short circuit mode (3) is a mode of occurrence of an upper-and-lower-arms short circuit caused when the semiconductor devices 5 of the upper and lower arms are simultaneously turned on.

The drive circuit 50 according to the first embodiment is required, in all of three short circuit modes (1) to (3), to detect an upper-and-lower-arms short circuit in any of these manners and to interrupt the collector current of the semiconductor device 5 before the amount of current flowing through the semiconductor device 5 reaches a short-circuit withstand capacity of the semiconductor device 5.

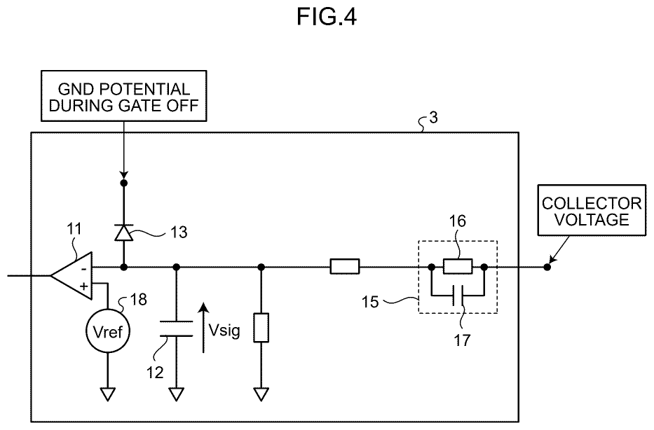

FIG. 4 is a diagram illustrating an example of the short circuit detection circuit included in each of the drive circuits according to the first embodiment. FIG. 4 illustrates an example circuit that uses the collector voltage-based detection method. The short circuit detection circuit 3 includes a comparator 11, a capacitor 12 for use in detection, a diode 13, and a resistor circuit 15, which are major components of the short circuit detection circuit 3. The resistor circuit 15 includes at least one resistor 16. A capacitor 17 is connected across the resistor 16. When the resistor circuit 15 is not. configured to include a physical capacitor, the capacitor 17 is to be construed as representing a parasitic capacitance of the resistor circuit 15. In addition, FIG. 4 illustrates the collector voltage of the semiconductor device 5 (not illustrated) as being applied to the negative terminal of the comparator 11 via the resistor circuit 15 and the like. A reference voltage Vref is applied to the positive terminal of the comparator 11.

An operation of the short circuit detection circuit 3 will next be described. First, when the semiconductor device 5 has its gate turned off, the diode 13 has a cathode potential of GND potential. This causes the portion connected to the negative terminal of the capacitor 12 to have a potential of almost GND potential, thereby causing no charging of the capacitor 12. Note that, in the short circuit detection circuit 3, GND potential is typically the emitter potential or the negative bias potential of the drive circuits 50. Alternatively, when the semiconductor device 5 has its gate turned on, the capacitor 12 is charged as the collector voltage increases. The voltage generated across the capacitor 12 is applied to the negative terminal of the comparator 11 as a detection voltage Vsig used by the short circuit detection circuit 3. The detection voltage Vsig increases according to a time constant determined by a resistance value of a resistive element including the resistor 16 existing on a path for charging the capacitor 12 and by a capacitance value of a capacitive element. including the capacitor 17 existing on the path for charging the capacitor 12.

The short circuit detection circuit 3 outputs a detection signal when the detection voltage Vsig is higher than the reference voltage Vref. When the short circuit detection circuit 3 outputs a detection signal, the control unit 4 can determine that an upper-and-lower-arms short circuit has occurred.

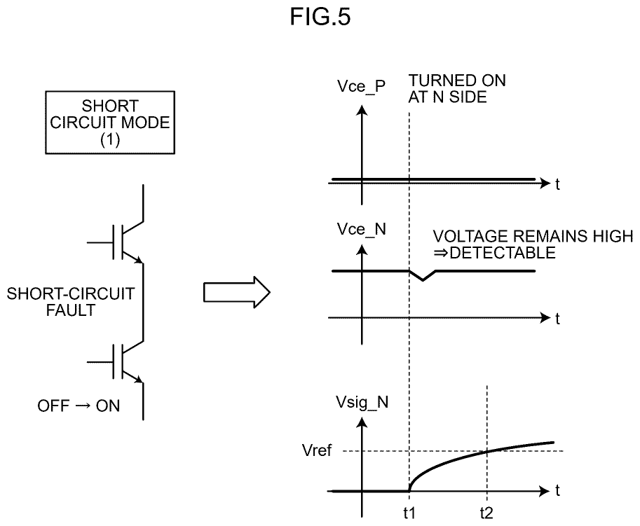

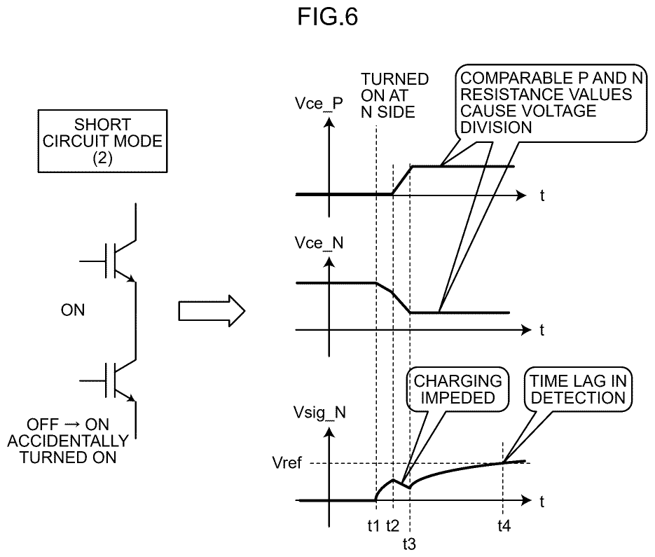

FIG. 5 is a set of diagrams for describing an operation in short circuit mode (1) performed in a typical short circuit detection circuit. Symbols used in FIG. 5 will be first described. The character “P” is used as a symbol meaning “upper arm”, and the character “N” is used as a symbol meaning “lower arm” The phrase “P side” therefore means “upper arm side”, and the phrase “N side” means “lower arm side”. In addition, the symbol “Vce_P” means the collector-emitter voltage (i.e., collector voltage) of the semiconductor device 5 on the upper arm side, and the symbol “Vce_N” means the collector-emitter voltage (i.e., collector voltage) of the semiconductor device 5 on the lower arm side. The symbol “Vsig_N” means the detection voltage Vsig of the short circuit detection circuit 3 on the lower arm side. Moreover, in FIG. 5 and FIGS. 6, 8, 10, and 11 mentioned later, the horizontal axis represents time, and the vertical axis represents voltage.

In short circuit mode (1), the P-side semiconductor device 5 is in a short-circuit fault condition, thereby causing the P-side semiconductor device 5 to have a very low resistance value. Thus, when the N-side semiconductor device 5 is turned on at time t1, the voltage is shared by the P-side and N-side semiconductor devices 5 to cause the N-side semiconductor device 5 to have a higher voltage, that is, the N-side collector voltage Vce_N to remain high. Accordingly, when the N-side semiconductor device 5 is turned on the N-side collector voltage Vce_N causes the N-side detection voltage Vsig_N to increase as illustrated. The upper-and-lower-arms short circuit therefore becomes detectable at time t2, which is a time when the detection voltage Vsig_N is about to exceed the reference voltage Vref. That is, in short circuit mode (1), the upper-and-lower-arms short circuit can be detected by using the N-side short circuit detection circuit 3, on which side no short-circuit fault has occurred.

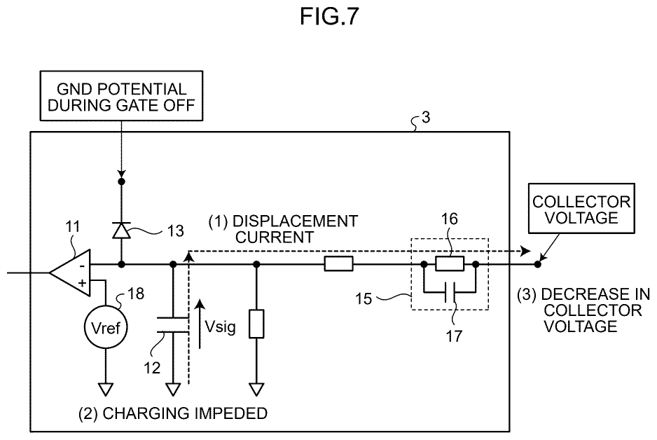

An operation in short circuit mode (2) will next be described. FIG. 6 is a set of diagrams for describing an operation in short circuit mode (2) performed in a typical short circuit detection circuit. FIG. 7 is a diagram for describing a displacement current that may flow in short circuit mode (2) in the typical short circuit detection circuit.

With reference to FIG. 6, consideration will be given to a case where the N-side semiconductor device 5 is turned on at time t1. In normal state operation, the P-side and N-side semiconductor devices 5 are not controlled to be in an “on” state simultaneously. This case is accordingly a case where the N-side semiconductor device 5 is accidentally turned on. In this case, the resistance value of the P-side semiconductor device 5 in an “on” state is comparable to the resistance value of the N-side semiconductor device 5 that has been turned on. The voltage applied to the P-side and N-side semiconductor devices 5 is accordingly shared by the P-side and N-side semiconductor devices 5. FIG. 6 illustrates that this phenomenon occurs after time t2, which is after time t1.

In addition, charging action on the capacitor 12 of the N-side short circuit detection circuit 3 is impeded after time t2. As illustrated in FIG. 6, the P-side collector voltage Vce_P rapidly increases after time t2, and the N-side collector voltage Vce_N rapidly decreases according thereto. This causes a displacement current to flow in a direction to impede the charging action on the capacitor 12 in the N-side short circuit detection circuit 3 as illustrated in FIG. 7. This displacement current causes the charge on the capacitor 12 to be discharged, and causes the collector voltage to decrease.

As illustrated in FIG. 6, the displacement current no longer flows and the charging action is restarted after time t3, but the time at which the reference voltage Vref is reached is delayed until time t4, that is the reference voltage Vref is reached at as late as time t4. This causes a time lag in detection, and presents an issue of difficulty in detecting the upper-and-lower-arme short circuit before the short-circuit withstand capacity of the semiconductor device 5 is reached.

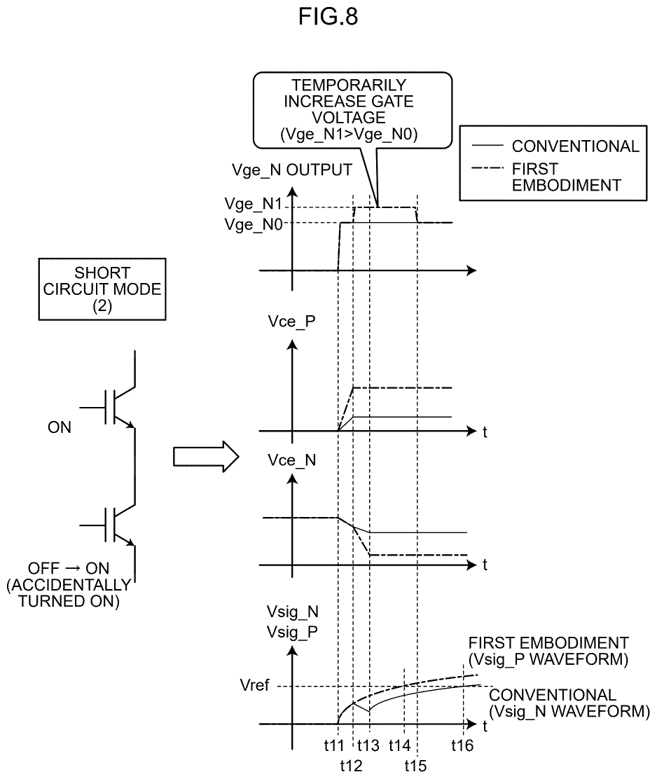

FIG. 8 is a set of diagrams for describing a control method to be used in the drive circuits according to the first embodiment. In each diagram of FIG. 8, the solid line represents an operation waveform obtained by a conventional method, and the dashed-and-dotted line represents an operation waveform obtained by the control method of the first embodiment. The operation waveforms represented by the solid lines are equivalent to those illustrated in FIG. 6. The waveforms of the collector voltages Vce_P and Vce_N illustrated in the middle portion of FIG. 8 correspond to the waveform of “Vce_P” of FIG. 6 and the waveform of “Vce_N” of FIG. In addition, the bottom portion of FIG. 8 represents the detection voltage Vsig_P of the P-side short circuit detection circuit 3.

Moreover, in the top portion of FIG. 8, the symbol “Vge_N” means the gate-emitter voltage (i.e., gate voltage) of the semiconductor device 5 on the lower arm side. In addition, “Vge_N0” is a predetermined voltage of the gate voltage. The term “predetermined voltage” as used herein refers to a gate voltage in a steady “on” state.

Moreover, the symbol “Vge_N1” means a voltage higher than the predetermined voltage Vge_N0. The voltage “Vge_N1” is referred to herein as “first voltage” as appropriate.

The control method of the first embodiment will next be described. The control unit 4 turns on the semiconductor device 5 of the arm on the driven side at time t11, and then performs control to temporarily increase the gate voltage Vge_N applied to that semiconductor device 5 to the first voltage Vge_N1, which is higher than the predetermined voltage Vge_N0, during a time period from time t12 to time t15. The time period from time t11 to time t12 may be a predetermined time period or may be any time period after the gate voltage of the semiconductor device 5 exceeds a mirror voltage.

If an operation is performed by a conventional method and the gate voltage Vge_N is not changed and maintained at the predetermined voltage Vge_N0, in the N-side detection voltage Vsig_N, a phenomenon would occur during a time period from time t12 to time t13 in which charging action on the capacitor 12 is impeded. Thus, the time at which the detection voltage Vsig_N reaches the reference voltage Vref is delayed until time t16.

In contrast, when the gate voltage Vge_N applied to the N-side semiconductor device 5 is temporarily increased to the first voltage Vge_N1, which is higher than the predetermined voltage Vge_N0, this causes voltage sharing to occur in such a manner that, as illustrated, a higher voltage is produced in the P-side semiconductor device 5, to which the relatively low predetermined voltage Vge_N0 is applied. This enables the upper-and-lover-arms short circuit to be detected at time t14, and a time lag in detection to be prevented. In addition, the semiconductor device 5 whose gate voltage Vge is increased can reduce switching loss and conduction loss.

Note that the voltage difference between the first voltage Vge_N1 and the predetermined voltage Vge_N0, i.e., the difference in the gate voltage Vge_N, can be any voltage difference having a sufficient magnitude to produce a significant difference in voltage sharing of the collector voltage between the P-side and N-side semiconductor devices 5, and can be determined according to characteristics of the semiconductor devices 5.

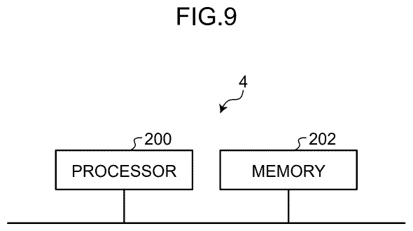

A hardware configuration for implementing functionality of the control unit 4 will next be described. FIG. 9 is a diagram illustrating an example of hardware configuration for implementing functionality of the control unit included in each of the drive circuits according to the first embodiment. The functionality of the control unit 4 is implemented by a processor 200 and a memory 202.

The processor 200 is a central processing unit (CPU) (also known as processing unit, computing unit, microprocessor, microcomputer, processor, and digital signal processor (DSP)), or a system large scale integration (LSI). The memory 202 is, by way of example, a non-volatile or volatile semiconductor memory such as a random access memory (RAM), a read-only memory (ROM), a flash memory, an erasable programmable read-only memory (EPROM), or an electrically erasable programmable read-only memory (EEPROM) (registered trademark).

The memory 202 stores a program for performing functionality of the control unit 4 according to the first embodiment. The processor 200 can perform the foregoing processing by reading a program stored in the memory 202, executing the program, and referring to data stored in the memory 202.

As described above the semiconductor device drive circuits according to the first embodiment are each a drive circuit for detecting a short circuit of semiconductor devices of upper and lower arms connected in series with each other on the basis of main terminal voltages of the semiconductor devices. The drive circuit includes a control unit, where the control unit individually controls a corresponding one of the semiconductor devices of the upper and lower arms, and applies a gate voltage to the corresponding one of the semiconductor devices to drive that semiconductor device. In this drive circuit, after turning on of the semiconductor device of an arm on a driven side, each of the control units performs control to temporarily increase the gate voltage applied to that semiconductor device to a first voltage, which is higher than a predetermined voltage. One of the control units that controls driving on the arm different from the arm on the driven side detects the short circuit of the semiconductor devices of the upper and lower arms on the basis of the main terminal voltages. This enables a drive circuit to be provided that is capable of preventing a time lag in detection that may occur in the collector voltage-based detection method. In addition, the semiconductor device whose gate voltage is increased can reduce switching loss and conduction loss.

Note that, in the foregoing control, the timing of changing of the gate voltage to the first voltage may be a time when a predetermined time period has elapsed since a turn-on command was issued to the semiconductor device of the arm on the driven side, or a time after the gate voltage of the semiconductor device of the arm on the driven side exceeds a mirror voltage. Changing the gate voltage at such timing enables the control operation to be performed without affecting a characteristic upon switching.

### Second Embodiment

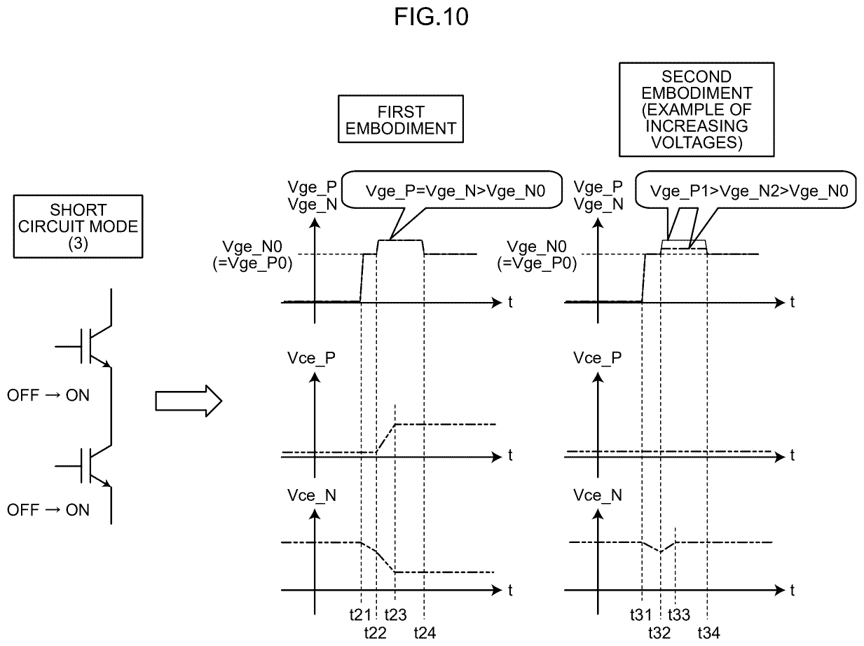

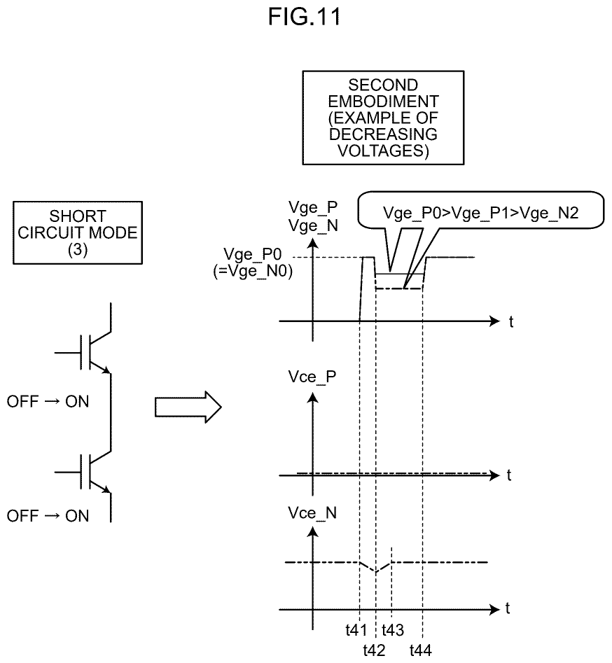

A second embodiment will be described with respect to a control method suitable for handling short circuit mode (3) with reference to FIGS. 10 and 11. FIG. 10 is a diagram for describing a first control method to be used in the drive circuits according to the second embodiment. FIG. 11 is a diagram for describing a second control method to be used in the drive circuits according to the second embodiment.

As described above, short circuit mode (3) is a mode in which an upper-and-lower-arms short circuit occurs due to simultaneous turning on of the P-side and N-side semiconductor devices 5. In short circuit mode (3), the P-side and N-side semiconductor devices 5 are simultaneously turned on. The control of the first embodiment is therefore performed in such a manner that the P-side and N-side control units 4 perform control to temporarily increase the gate voltages Vge, i.e., the gate voltage Vge_P and the gate voltage Vge_N. This operation is illustrated in the middle portion of FIG. 10. In FIG. 10, the waveforms of “Vge_P” are represented by solid lines, and the waveforms of “Vge_N” are represented by dashed-and-dotted lines. In addition, the waveforms of “Vce_P” and “Vce_N” are each represented by a dashed-double-dotted line.

When the P-side and N-side semiconductor devices 5 are simultaneously turned on, the P-side and N-side control units 4 act simultaneously and perform control simultaneously to increase the respective gate voltages. This no longer causes a significant difference in voltage sharing of the collector voltage between the P-side and N-side semiconductor devices 5. This may introduce a time lag in detection of the upper-and-lower-arme short circuit.

As such, in the second embodiment, different setting values are used in the P side and the N side for the voltage to which the gate voltage Vge is increased. The right portion of FIG. 10 illustrates an example in which the gate voltage Vge P controlled by the P-side control unit 4 is higher than the gate voltage Vge_N controlled by the N-side control unit 4. That is, when the P-side control unit 4 has turned on the corresponding semiconductor device 5, the P-side control unit 4 performs control to temporarily increase the gate voltage applied to that semiconductor device 5 to a first voltage Vge_P1, which is higher than the predetermined voltage Vgs_P0 (=Vge_N0), which is the gate voltage in a steady “on” state. On the other hand, when the N-side control unit 4 has turned on the corresponding semiconductor device 5, the N-side control unit 4 performs control to temporarily increase the gate voltage applied to that semiconductor device 5 to a second voltage Vge_N2, which is higher than the predetermined voltage Vge_N0 (=Vge_P0) and lower than the first voltage Vge_P1. Such control operation provides voltage sharing in such a manner that a higher collector voltage is produced in the N-side semiconductor device 5, to which the relatively low second voltage Vge_N2 is applied. This enables the upper-and-lower-arms short circuit to be detected and a time lag in detection to be prevented.

Note that although FIG. 10 illustrates, by way of example, a case where the first voltage Vge_P1 used in control of the P-side control unit 4 is higher than the second voltage Vge_N2 used in control of the N-side control unit 4, the operation is not limited to this example. It is sufficient that control can be performed to cause a significant difference between the P-side collector voltage Vce P and the N-side collector voltage Vce_N, and accordingly, the second voltage Vge_N2 may be a voltage higher than the first voltage Vge_P1. Performing such control also has an effect of enabling the upper-and-lower-arms short circuit to be detected and a time lag in detection to be prevented.

In addition, although FIG. 10 illustrates, by way of example, a case where the first voltage Vge_P1 and the second voltage Vge_N2 are both higher than the predetermined voltage Vge_P0 (=Vge_N0), the operation is not limited to this example. One of the first voltage Vge_P1 and the second voltage Vge_N2 may be a voltage lower than the predetermined voltage Vge_P0 (=Vge_N0). Performing such control also has an effect of enabling the upper-and-lower-arme short circuit to be detected and a time lag in detection to be prevented.

Meanwhile, FIG. 11 illustrates an example in which the first voltage Vge_P1 and the second voltage Vge_N2 are both lower than the predetermined voltage Vge_P0 (=Vge_N0). The definitions of lines are similar to those of FIG. 10.

When the P-side control unit 4 has turned on the corresponding semiconductor device 5, the P-side control unit 4 performs control to temporarily decrease the gate voltage applied to that semiconductor device 5 to the first voltage Vge_P1, which is lower than the predetermined voltage Vge_P0 (=Vge_N0). On the other hand, when the N-side control unit 4 has turned on the corresponding semiconductor device 5, the N-side control unit 4 performs control to temporarily decrease the gate voltage applied to that semiconductor device 5 to the second voltage Vge_N2, which is lower than the predetermined voltage Vge_N0 (=Vge_P0) and lower than the first voltage Vge_P1. Such control operation provides voltage sharing in such a manner that a higher collector voltage is produced in the N-side semiconductor device 5, to which the relatively low second voltage Vge_N2 is applied. This enables the upper-and-lower-arms short circuit to be detected and a time lag in detection to be prevented.

Note that although FIG. 11 illustrates, by way of example a case where the second voltage Vge_N2 used in control of the N-side control unit 4 is lower than the first voltage Vge_P1 used in control of the P-side control unit 4, the operation is not limited to this example. It is sufficient that control can be performed to cause a significant difference between the P-side collector voltage Vce_P and the N-side collector voltage Vce_N, and accordingly, the first voltage Vge_P1 may be a voltage lower than the second voltage Vge_N2. Performing such control also has an effect of enabling the upper-and-lower-arms short circuit to be detected and a time lag in detection to be prevented.

In addition, although FIG. 11 illustrates, by way of example, a case where the first voltage Vge_P1 and the second voltage Vge_N2 are both lower than the predetermined voltage Vge_P0 (=Vge_N0), the operation is not limited to this example. One of the first voltage Vge_P1 and the second voltage Vge_N2 may be a voltage higher than the predetermined voltage Vge_P0 (=Vge_N0). Performing such control also has an effect of enabling the upper-and-lower-arms short circuit to be detected and a time lag in detection to be prevented.

As described above, the semiconductor device drive circuits according to the second embodiment are each a drive circuit for detecting a short circuit of semiconductor devices of upper and lower arms connected in series with each other on the basis of main terminal voltages of the semiconductor devices. The drive circuit includes a control unit, where the control unit individually controls a corresponding one of the semiconductor devices of the upper and lower arms, and applies a gate voltage to the corresponding one of the semiconductor devices to drive that semiconductor device. In this drive circuit, when one control unit of two of the control units that drive the semiconductor devices of the upper and lower arms has turned on a corresponding one of the semiconductor devices, the one control unit performs control to temporarily increase the gate voltage applied to the corresponding one of the semiconductor devices to a first voltage, which is higher than a predetermined voltage. After turning on of the semiconductor device of an arm on a driven side, each of the control units performs control to temporarily increase the gate voltage applied to that semiconductor device to the first voltage, which is higher than the predetermined voltage. When another control unit of the two of the control units has turned on a corresponding one of the semiconductor devices, the other control unit performs control to temporarily change the gate voltage applied to the corresponding one of the semiconductor devices to a second voltage, which is higher or lower than the first voltage. This enables a drive circuit to be provided that is capable of preventing a time lag in detection that may occur in the collector voltage-based detection method. In addition, the drive circuits according to the second embodiment can handle short circuit mode (3), which is a short circuit mode in a very special case, and can therefore ensure performing control to prevent a time lag in detection.

Note that, in the foregoing control, when the one control unit of the two of the control units that drive the semiconductor devices of the upper and lower arms has turned on the corresponding one of the semiconductor devices, the one control unit may perform control to temporarily decrease the gate voltage applied to that semiconductor device to a first voltage that is lower than the predetermined voltage. In this case, when the other control unit of the two of the control units has turned on a corresponding one of the semiconductor devices, the other control unit performs control to temporarily change the gate voltage applied to that semiconductor device to a second voltage, which is higher or lower than the first voltage.

In addition, in the foregoing control, when the first voltage is higher than the second voltage, the control unit that causes the second voltage to be applied can detect the short circuit of the semiconductor devices of the upper and lower arms on the basis of the main terminal voltages. Alternatively, when the first voltage is lower than the second voltage, the control unit that causes the first voltage to be applied can detect the short circuit of the semiconductor devices of the upper and lower arms on the basis of the main terminal voltages.

Moreover, in the foregoing control, the timing of changing the gate voltage to the first voltage may be a time when a predetermined time period has elapsed since a turn-on command was issued to the semiconductor device of the arm on the driven side, or a time after the gate voltage of the semiconductor device of the arm on the driven side exceeds a mirror voltage. Changing the gate voltage at such timing enables the control operation to be performed without affecting a characteristic upon switching.

The configurations described in the foregoing embodiments are merely examples. These configurations may be combined with another known technology, and configurations of different embodiments may be combined together. Moreover, such configurations may be partly omitted and/or modified without departing from the gist.

### REFERENCE SIGNS LIST

1 DC power source; 2, 2a, 2b gate drive circuit; 3, 3a, 3b short circuit detection circuit; 4, 4a, 4b control unit; 5, 5a, 5b, 5c, 5d, 5e, 5f semiconductor device; 6 motor; 11 comparator; 12, 17 capacitor; 13 diode, 15 resistor circuit; 16 resistor; 50, 50a, 50b drive circuit, 200 processor; 202 memory.

1. A semiconductor device drive circuit for detecting a short circuit of semiconductor devices of upper and lower arms connected in series with each other on a basis of main terminal voltages of the semiconductor devices, the semiconductor device drive circuit comprising semiconductor device controllers, the semiconductor device controllers each individually controlling a corresponding one of the semiconductor devices of the upper and lower arms, and each applying a gate voltage to the corresponding one of the semiconductor devices to drive the one of the semiconductor devices, wherein
after turning on of one of the semiconductor devices of an arm on a driven side, each of the semiconductor device controllers performs control to temporarily increase a gate voltage applied to the one of the semiconductor devices to a first voltage, the first voltage being higher than a predetermined voltage, and
a semiconductor device controller of the semiconductor device controllers that controls driving on an arm different from the arm on the driven side detects the short circuit of the semiconductor devices of the upper and lower arms on a basis of the main terminal voltages.

2. The semiconductor device drive circuit according to claim 1, wherein
each of the semiconductor device controllers changes the gate voltage to the first voltage when a predetermined time period has elapsed since a turn-on command is issued to the one of the semiconductor devices of the arm on the driven side.

3. The semiconductor device drive circuit according to claim 1, wherein
each of the semiconductor device controllers changes the gate voltage to the first voltage after the gate voltage of the one of the semiconductor devices of the arm on the driven side exceeds a mirror voltage.

4. A semiconductor device drive circuit for detecting a short circuit of semiconductor devices of upper and lower arms connected in series with each other on a basis of main terminal voltages of the semiconductor devices, the semiconductor device drive circuit comprising semiconductor device controllers, the semiconductor device controllers each individually controlling a corresponding one of the semiconductor devices of the upper and lower arms, and each applying a gate voltage to the corresponding one of the semiconductor devices to drive the one of the semiconductor devices, wherein
when one semiconductor device controller of two of the semiconductor device controllers that drive the semiconductor devices of the upper and lower arms has turned on a corresponding one of the semiconductor devices, the one semiconductor device controller performs control to temporarily increase the gate voltage applied to the corresponding one of the semiconductor devices to a first voltage, the first voltage being higher than a predetermined voltage, and
when another semiconductor device controller of the two of the semiconductor device controllers has turned on a corresponding one of the semiconductor devices, the another semiconductor device controller performs control to temporarily change the gate voltage applied to the corresponding one of the semiconductor devices to a second voltage, the second voltage being higher or lower than the first voltage.

5. A semiconductor device drive circuit for detecting a short circuit of semiconductor devices of upper and lower arms connected in series with each other on a basis of main terminal voltages of the semiconductor devices, the semiconductor device drive circuit comprising semiconductor device controllers, the semiconductor device controllers each individually controlling a corresponding one of the semiconductor devices of the upper and lower arms, and each applying a gate voltage to the corresponding one of the semiconductor devices to drive the one of the semiconductor devices, wherein
when one semiconductor device controller of two of the semiconductor device controllers that drive the semiconductor devices of the upper and lower arms has turned on a corresponding one of the semiconductor devices, the one semiconductor device controller performs control to temporarily decrease the gate voltage applied to the corresponding one of the semiconductor devices to a first voltage, the first voltage being lower than a predetermined voltage, and
when another semiconductor device controller of the two of the semiconductor device controllers has turned on a corresponding one of the semiconductor devices, the another semiconductor device controller performs control to temporarily change the gate voltage applied to the corresponding one of the semiconductor devices to a second voltage, the second voltage being higher or lower than the first voltage.

6. The semiconductor device drive circuit according to claim 4, wherein
when the first voltage is higher than the second voltage, the semiconductor device controller on a side that causes the second voltage to be applied detects the short circuit of the semiconductor devices of the upper and lower arms on a basis of the main terminal voltages, and
when the first voltage is lower than the second voltage, the semiconductor device controller on a side that causes the first voltage to be applied detects the short circuit of the semiconductor devices of the upper and lower arms on a basis of the main terminal voltages.

7. The semiconductor device drive circuit according to claim 4, wherein
each of the semiconductor device controllers changes the gate voltage to the first voltage or to the second voltage when a predetermined time period has elapsed since a turn-on command is issued to one of the semiconductor devices of an arm on a driven side.

8. The semiconductor device drive circuit according to claim 4, wherein
each of the semiconductor device controllers changes the gate voltage to the first voltage or to the second voltage after the gate voltage of one of the semiconductor devices of an arm on a driven side exceeds a mirror voltage.

9. The semiconductor device drive circuit according to claim 5, wherein
when the first voltage is higher than the second voltage, the semiconductor device controller on a side that causes the second voltage to be applied detects the short circuit of the semiconductor devices of the upper and lower arms on a basis of the main terminal voltages, and
when the first voltage is lower than the second voltage, the semiconductor device controller on a side that causes the first voltage to be applied detects the short circuit of the semiconductor devices of the upper and lower arms on a basis of the main terminal voltages.

10. The semiconductor device drive circuit according to claim 5, wherein
each of the semiconductor device controllers changes the gate voltage to the first voltage or to the second voltage when a predetermined time period has elapsed since a turn-on command is issued to one of the semiconductor devices of an arm on a driven side.

11. The semiconductor device drive circuit according to claim 6, wherein
each of the semiconductor device controllers changes the gate voltage to the first voltage or to the second voltage when a predetermined time period has elapsed since a turn-on command is issued to one of the semiconductor devices of an arm on a driven side.

12. The semiconductor device drive circuit according to claim 9, wherein
each of the semiconductor device controllers changes the gate voltage to the first voltage or to the second voltage when a predetermined time period has elapsed since a turn-on command is issued to one of the semiconductor devices of an arm on a driven side.

13. The semiconductor device drive circuit according to claim 5, wherein
each of the semiconductor device controllers changes the gate voltage to the first voltage or to the second voltage after the gate voltage of one of the semiconductor devices of an arm on a driven side exceeds a mirror voltage.

14. The semiconductor device drive circuit according to claim 6, wherein
each of the semiconductor device controllers changes the gate voltage to the first voltage or to the second voltage after the gate voltage of one of the semiconductor devices of an arm on a driven side exceeds a mirror voltage.

15. The semiconductor device drive circuit according to claim 9, wherein
each of the semiconductor device controllers changes the gate voltage to the first voltage or to the second voltage after the gate voltage of one of the semiconductor devices of an arm on a driven side exceeds a mirror voltage.
